(19) United States
(12) Patent Application Publication
(10) Pub. No.: US 2014/0337143 A1
(43) Pub. Date: Nov. 13, 2014

(54) DIGITAL ADVERTISING BID OPTIMIZATION

(71) Applicants: Daniel L. Petersen, Los Angeles, CA (US); Todd W. Webber, Birmingham, MI (US)

(72) Inventors: Daniel L. Petersen, Los Angeles, CA (US); Todd W. Webber, Birmingham, MI (US)

(73) Assignee: LocalBiz Now, LLC, Auburn Hills, MI (US)

(21) Appl. No.: 13/888,736

(22) Filed: May 7, 2013

(51) Int. Cl. G06Q 30/02

(52) U.S. Cl. CPC G06Q 30/0275
USPC 705/14.71

(57) ABSTRACT

A plurality of outcomes resulting from display of a digital advertisement are defined. A score is assigned to each of the outcomes. Outcomes are tracked from the display of the digital advertisement, thereby generating a set of tracked outcomes. The outcomes are aggregated according to a group of attributes associated with the display of the digital advertisement. A group-specific bid modifier for the digital advertisement is determined.

### BACKGROUND INFORMATION

Advertisers allocate significant budgets to purchase the display of digital advertisements. For example, various search engines allow advertisers to select categories, keywords, etc. which, when included in a search query, may trigger display of the advertiser's advertisement in a list of search results or the like. Advertisers generally submit, e.g., via an application program interface (API) provided by a search engine, bids to the search engine in conjunction with selected categories, keywords, etc., for display of advertisers' digital advertisements. Thus, when the search engine receives a query including certain keywords, for example, the search engine checks bid amounts of various advertisers who have submitted advertisements associated with one or more of the keywords in the query. Accordingly, an advertiser may wish for its bid amount to be high enough to be successful, but not higher than necessary, particularly in view of a budget amount allocated to an advertising campaign including the advertisement. Advertisers may wish to optimize bids in other ways. Unfortunately, mechanisms for certain optimizations have been lacking.

### BRIEF DESCRIPTION OF THE DRAWINGS

FIG. 1 is a block diagram of a system for providing digital advertisements.

FIG. 2 illustrates an exemplary process 200 for establishing a contract for a digital advertising campaign.

FIG. 3 illustrates an exemplary process 300 for generating contract-specific bid modifiers.

FIG. 4 illustrates an exemplary process 400 for generating contract and group-specific bid modifiers.

FIG. 5 illustrates an exemplary process 500 for bidding to provide, and providing, digital advertisements.

### DETAILED DESCRIPTION OF PREFERRED EMBODIMENTS

### Introduction

Disclosed herein are certain systems, apparatuses, and methods, including such as may be embodied as instructions stored on a computer-readable medium such a computer memory, removable media, etc., and executable by a processor. For example, mechanisms may be used to specify a group of one or more attributes that may be associated with an advertiser's bid to display a digital advertisement. Exemplary attributes include identifiers for traffic sources such as search engines that display advertisements, geographic locations, categories of search keywords, etc. By associating a group with user activity resulting from display of a digital advertisement, sometimes referred to herein as an “outcome” of displaying the advertisement, it is possible to adjust a bid amount for an advertisement, thereby more efficiently using an advertiser's budget for an advertising campaign, as well as maximizing revenue for an advertising platform provider.

### System Overview

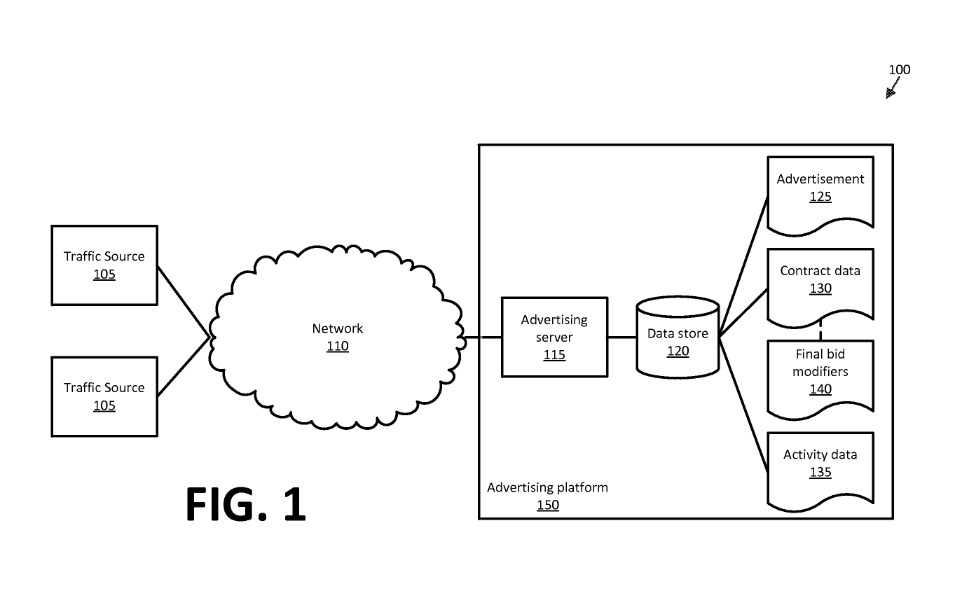

FIG. 1 is a block diagram of a system 100 for providing digital advertisements. A plurality of traffic sources 105 each may generate queries sent via a network 110 to an advertising server 115 that is included in an advertising platform 150. Further in the advertising platform 150, the advertising server 115 includes or is communicatively coupled to a data store 120. The data store 120 includes at least one, and generally more, digital advertisements 125, as well as contract data 130 that includes parameters for an advertising campaign to provide an advertisement 125. The data store 120 generally further includes activity data 135 relating to advertisements 125. The data store 120 yet further generally includes final bid modifiers 140, which as described further below, may be determined according to contract data 130 and activity data 135.

Traffic sources 105 include known providers of Internet traffic, e.g., search engines such as the Google search engine provided by Google, Inc. of Mountain View, Calif., and the Bing search engine provided by Microsoft Corporation of Redmond, Wash. Although two traffic sources 105 are shown in FIG. 1 for purposes of illustration, it is to be understood that the system 100 could include three or more traffic sources 105. As is generally known, traffic sources 105 may send bid requests to advertising server 115, e.g., according to a keyword or the like supplied by an advertiser, e.g., provider of an advertisement 125. The advertising server 115, in return, may provide a bid for an advertisement 125 to be displayed, e.g., as part of a response displayed by the traffic source 105 to a query received by the traffic source 105.

The network 110 is generally a packet network, e.g., operating according to transfer control protocol/Internet protocol (TCP/IP). Although one network 115 is shown, the network 115 may include one or more networks, such as the Internet, a wide area network, a local area network, a cellular network, a wireless network, etc.

The advertising server 115 may be one or more computer servers, generally including at least one processor and at least one memory, the memory storing instructions executable by the processor, including instructions for carrying out various of the steps and processes described herein. The data store 120 may be included in the server 115 and/or may be a separate computing device. The data store 120, possible examples of which are discussed further below, generally includes computer-executable instructions for storing and managing data, as well as a computer-readable medium for data storage.

Advertisements 125 may include what are sometimes referred to as a “paid listings,” “Internet display advertisements,” etc. In general, an advertisement 125 is stored by the advertising server 115, e.g., in the data store 120, and/or a traffic source 105, such that the advertisement 125 may be displayed by the traffic source 105, e.g., upon a successful bid. In addition to storing bid amounts related to an advertisement 125 and/or an advertising campaign, a traffic source 105 may also store one or more categories, keywords, etc., associated with the advertisement 125 and/or campaign, so that bidding to have the advertisement displayed by the traffic source 105 is triggered when a query or the like includes a relevant category, keyword, etc.

Contract data 130 includes data concerning a contract between an advertiser associated with an advertisement 125 and the operator of the advertising server 115. A contract generally relates to a “campaign” in which an advertisement 125 is to be provided to traffic sources 105. Contract data 130 accordingly may include a budget for the campaign, a start date and a duration for the campaign (or a start date and an end date from which a duration may be determined), and one or more locations for the campaign.

For example, a budget may be provided in the form of an amount of money that may be spent in a period of time, e.g., per month, for the duration of the campaign, etc., to display the advertisement 125. A budget amount included in contract data 130 generally is generally at least partly the basis for a bid amount that may be submitted to a traffic source 105 such as a search engine for display of the advertisement 125.

A campaign “location” may be a geographic location associated with an advertisement 125, i.e., a location at which the advertisement 125 may be targeted. For example, a location could be “Los Angeles,” Detroit,” “California,” “Michigan,” etc. Campaign locations may be used to determine whether to provide a bid to a traffic source 105 to display an advertisement 125. For example, an advertiser may wish to have an advertisement 125 displayed only in response to queries originating in a particular state, a particular set of cities, etc. One or more target locations may be associated with an advertisement. The one or more target locations for an advertisement 125 may be determined according to one or more physical locations of an advertiser, e.g., an advertiser in Detroit, Mich., and Washington, D.C., may want to advertise in Detroit as well as its suburbs Livonia and Plymouth, and also Washington and its suburbs Bethesda, Md. and McLean, Va.

Activity data 135 includes data relating to campaigns. For example, activity data 135 may include an actual amount spent on a campaign, e.g., an amount spent on successful bids. In some cases, the advertising server 115 may implement what is referred to as a “cut-off.” A cut-off is a ceiling or limit that may be placed on an amount that may be spent on a campaign in a specified period of time, e.g., one day. The purpose of a cut-off is to pace the spending of a campaign budget, and to prevent the campaign budget from being entirely spent prior to the end of a campaign. Occurrences of a cut-off being invoked to prevent a bid from being submitted to a traffic source 105 may be recorded and included in activity data 135.

Activity data 135 also generally includes data relating to outcomes of displaying an advertisement 125. In general, an “outcome” of displaying an advertisement 125 refers to a result such as a user action. Examples of outcomes include clicking on a particular link, viewing a coupon, sending an e-mail using a provided “send e-mail link,” etc. Outcomes may be tracked and stored in data store 120 as part of activity data 135 using a variety of known mechanisms.

For example, an outcome may be recorded when a user views a web page; when the page is provided to a web browser, the outcome, e.g., a user's click on a particular link, may be recorded in the browser's session data and stored in the data store 120, e.g., according to known mechanisms. Further, outcome data may be associated with a keyword or the like, e.g., a web page view may be selected after a user viewed a digital advertisement provided to the user in association with a keyword. Such keyword may be included in session data relating to a user session following selection of the digital advertisement, and may be stored with an outcome, e.g., as activity data 135 in the data store 120.

Further, outcomes may be assigned rankings or scores according to their relative desirability. For example, by default an outcome may have a score of 1, less desirable outcomes may have scores of between 0 and 1, while more desirable outcomes could have scores of greater than 1. For example, a recipient of an advertisement 125 clicking on a “view coupon” link included in the advertisement 125 may be a very desirable outcome, which therefore could be assigned a higher score, e.g., 2, whereas if the advertisement 125 recipient clicks on a particular link to go to a web site, that outcome may be less desirable, and therefore assigned a lower score, e.g., 0.5. To continue this example, default outcome scores of 1 could be assigned to outcomes such as printing a coupon, clicking on another particular link, etc.

Accordingly, outcomes may be stored in activity data 135 according to a number of instances of an outcome along with a score for the respective outcome. Further, activity data 135 relating to outcomes may be aggregated in various ways. For example, outcome activity data 135 may be aggregated for what are referred to herein as “groups” of attributes related to a bid. As mentioned above, such attributes may include identifiers for traffic sources 105, geographic locations, keyword categories, etc., associated with a bid and/or the subsequent display of an advertisement 125.

Final bid modifiers 140 are factors that may be applied to adjust a maximum bid amount for a campaign in particular instances, and may further relate to a grouping of one or more attributes of a bid, e.g., a traffic source 105 and/or other attributes that may be associated with a bid, e.g., category of keyword, geographic location, etc. Determination and use of final bid modifiers 140 are described further below. As further explained below, bid modifiers 140 may be included in contract data 130.

### Process Flows

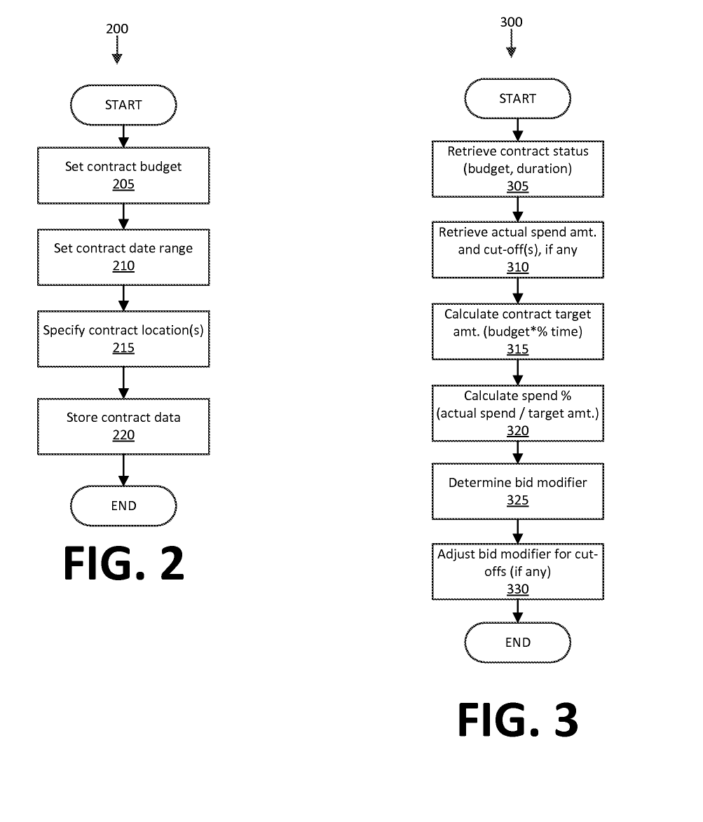

FIG. 2 illustrates an exemplary process 200 for establishing a contract for a digital advertising campaign. The process 200 begins in a block 205, in which a contract budget is specified. For example, a user of a graphical interface provided by the advertising server 115 may use the interface to specify a budget amount for a campaign.

Next, in a block 210, a date range for the contract is specified. For example, a contract start date and an date may be specified, from which a contract duration may be determined.

Next, in a block 215, contract locations are specified. For example, as noted above, a campaign for an advertisement 125 may be restricted to displaying the advertisement 125 to users in specified geographic locations.

Next, in a block 220, contract data 130, collected as described above with respect to blocks 205-215, is stored in the data store 120. It is to be understood that contract data 130 could be stored in the data store 120 at other times, e.g., upon being input in the respective blocks 205-215.

Following the block 220, the process 200 ends.

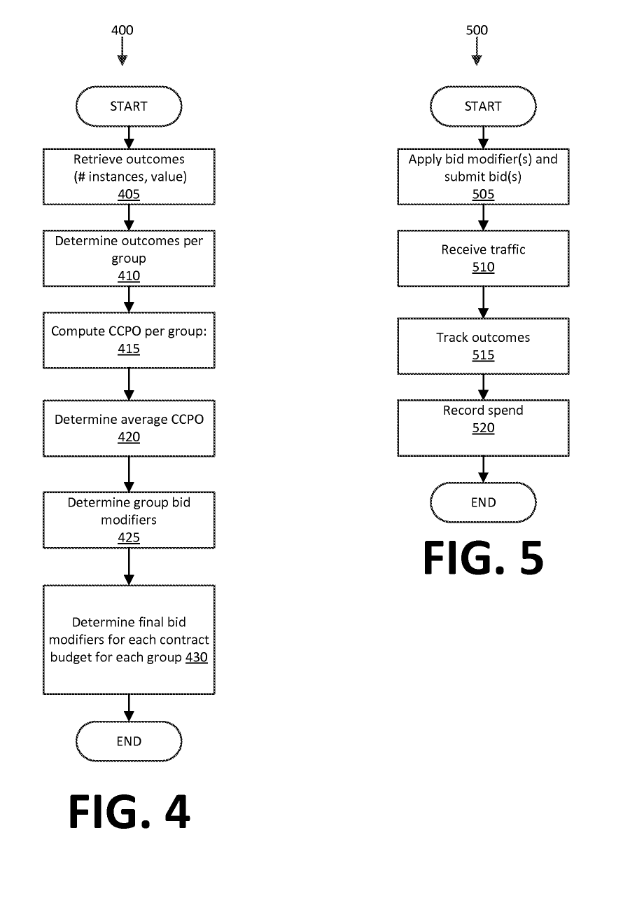

FIG. 3 illustrates an exemplary process 300 for generating contract-specific bid modifiers, i.e., the process 300 is executed one time for each contract-specific bid modifier generated. Contract-specific bid modifiers are used as described below with respect to the process 400 of FIG. 4 to generate final bid modifiers 140.

The process 300 begins in a step 305, in which the server 115 retrieves, e.g., from the data store 120, contract data 130, including the contract budget amount and the contract duration.

Next, in a block 310, the server 115 retrieves, e.g., from the data store 120, activity data 135, including an actual amount spent for the campaign, as well as records of any cut-offs.

Next, in a block 315, the server 115 calculates a target budget amount, i.e., an amount that should have spent for display of an advertisement 125 that is the subject of the campaign, based on the percentage of the contract's duration that has elapsed. Thus, a target budget amount may be calculated by multiplying a contract's budget amount by a percentage of contract duration of elapsed. For example, if a budget amount is $100, and 50 percent of the contract duration has elapsed, then the target budget amount would be $50.

Next, in a block 320, the server 115 calculates an actual spend percentage, i.e., an percentage of the contract budget that has actually been spent. Thus, an actual spend percentage may be calculated by dividing the actual spend amount retrieved in block 310 by the target budget amount calculated as described with respect to the block 315. A formula for spend percentage could be:

SP=TS/AS,

where SP represents spend percentage, TS represents target budget (or spend) amount, and a asked represents the actual spend amount. For example, if an actual spend amount was $50, and the target budget amount was $45, then the actual spend percentage would be 110 percent. If an actual spend amount was $55, and the target budget amount was $50, then the actual spend percentage would be 91 percent.

Next, in a block 325, a contract-specific bid modifier is determined based on the actual spend percentage determined as described above with respect to the block 320. In general, if the actual spend percentage is less than 100 percent, then the contract-specific bid modifier should be a factor greater than one, i.e., should specify that a bid should be modified to be in excess of a specified contract bid amount. That is, an actual spend percentage of less than 100 percent means that a contract budget is not on pace to be entirely consumed, and therefore increasing bid amounts for an advertisement 125 is appropriate. Conversely, if the actual spend percentage is greater than 100 percent, then the contract-specific bid modifier generally should be a factor less than one, i.e., should specify that a bid should be modified to be less than a specified contract bid amount. That is, an actual spend percentage of greater than 100 percent means that a contract budget is on pace to be consumed before a contract duration has ended.

Various rules may be implemented for determining a contract-specific bid modifier. For example, the contract-specific bid modifier may simply be a reciprocal of the actual spend percentage. In this example, if the actual spend percentage was 90 percent, then the contract-specific bid modifier would be 110 percent, or 1.1. Conversely, an actual spend percentage of 110 percent, would result in a contract-specific bid modifier of 90 percent, or 0.9.

In practice, it has been determined that more complex rules for determining a contract-specific bid modifier may be beneficial. For example, it has been found that it is often beneficial to introduce an additional factor to decrease the impact of a bid modifier to prevent a modification of the contract-specific bid modifier from having an unexpected, or greater than desired, impact on spending the contract budget. Accordingly, one implementation uses the following logic to determine contract-specific bid modifiers:

If SP>1, then CSBM=((SP−1)/AF)+1;

If SP<1, then CSBM=1−((1−SP)/AF).

In the above statement, SP is spend percentage as stated above, CSBM is the contract-specific bid modifier, and AF is the adjustment factor. According to the above logic, and assuming a value of 2 for the adjustment factor, for example, a spend percentage of 0.9 would result in a contract-specific bid modifier of 1.05.

In general, it has been determined that linear changes, i.e., increases or decreases, in bid amounts, generally do not correlate to linear changes in actual spend amounts. Accordingly, various values may be chosen for the adjustment factor. In one implementation, a value of 2 has been found to appropriately smooth changes, i.e., increases or decreases, in the actual spend amount following a change of the contract-specific bid modifier (and, consequently, the final bid modifier 140 discussed further below).

Next, in a block 330, the contract-specific bid modifier determined in the block 325 is adjusted, i.e., decreased, for any cut-offs. For example, if a campaign has experienced a certain number of cut-offs in a period of time, it may be desirable to reduce a contract-specific bid modifier to prevent the campaign from exhausting an amount of a contract budget that should be spent within, for example, a day. Adjusted contract-specific bid modifiers may be stored in the data store 120, e.g., as part of contract data 130.

Whether to apply a cut-off may depend on a time of day. For example, if a contract's daily budget is entirely spent by noon, then a cut-off may be appropriate. However, if the contract's daily budget is entirely spent at 11 PM, this is roughly a desired result, and a cut-off may not be appropriate. Accordingly, a rule may exist to use a cut-off only at certain times of day, before a certain time of day, etc. Further, a rule may exist to use a cut-off at a certain time of day when a certain amount of a contract's daily budget had been expended. For example, a rule could state to use a cut-off at 10 PM if 90 percent or more of a contract's daily budget was expended. Cut-offs could also vary according to a day of the week, or a specific time of day on a specific day of the week. Further, as mentioned above, cut-offs are determined according to a daily budget; note that the daily budget may be calculated for a campaign on a daily basis according to expenditures for the campaign to date.

In any event, adjusting the contract-specific bid modifier for a cut-off may be done according to various rules. For example, in one implementation, a time of day of a cut-off is taken into account. In this example, a percentage of a day elapsed prior to a cut-off being done is determined, e.g., if a cut-off occurred at 9 PM, i.e., 21 hours into a day, then the percentage of the date elapsed prior to the cut-off would be 87.5 percent. This percentage may then be used to determine a cut-off adjustment factor that may be applied to the final bid modifier 140 discussed below. For example, a cut-off adjustment factor may be computed according to the formula:

CA=1−(ETP/AF),

where CA represents the cut-off adjustment factor, ETP represents the elapsed time percentage of a day prior to the cut-off for the contract, and AF is the adjustment factor mentioned above. Accordingly, if ETP is a 87.5 percent, then the cut-off adjustment factor CA would be 93.75 percent. An adjusted contract-specific bid modifier CSMB could be computed according to the formula:

CSBM_{adj}=CSMB*CA.

For example, if CSBM is 90 percent, and the cut-off adjustment factor CA is 93.75 percent, then the adjusted contract-specific bid modifier CSBM_{adj} would be 84.375 percent.

Note that although the bid modifier determined in the block 330 is referred to as contract-specific, it may also be thought of as generic to the contract and to advertisement 125 associated with the contract. That is, the contract-specific bid modifier is generic for a contract in an advertisement 125 in contrast to the group-specific bid modifier discussed further below with respect to the process 400.

Following the block 330, the process 300 ends.

FIG. 4 illustrates an exemplary process 400 for generating contract and group-specific bid modifiers.

The process 400 begins in a block 405, in which the server 115 retrieves activity data 135 that includes outcomes related to a campaign. As discussed above, activity data 135 related to outcomes generally includes a number of instances of an outcome for a campaign, along with a score of the outcome for the campaign.

Next, in a block 410, outcomes are aggregated for specified groups. For example, outcomes could be aggregated according to groups of traffic sources 105, geographic locations, and/or or some other combination of attributes, such as according to advertisements 125 returned to respective traffic sources 105 in one or more particular locations. In any event, block 410 results in sets of outcomes that are each associated with a specified group.

Next, in a block 415, a computed cost per outcome (CCPO) is calculated for each group specified as described above with respect to the block 410. For example, a CCPO could be calculated for each traffic source 105 in a set of traffic sources. CCPO for a group may be computed according to the formula

CCPO=Cost/(# instances₁*value₁+# instances₂*value₂+ . . . # instancesₙ*valueₙ).

In this formula, “Cost” represents an aggregate cost for advertisements 125 associated with the group, e.g., an aggregate amount of successful bid amounts for advertisements 125 associated with the group within a period of time to which the outcome data relates. “#instances” represents a number of times that a particular outcome has occurred in the campaign for the specified group, and “value” indicates a value, e.g. a, associated with the outcome. As should be apparent, the CCPO formula may be computed for one or more, generally for two or more, outcomes relating to a group. Further, a CCPO could also be computed for a combination of groups, which could be useful if it is desired to compute a final bid modifier 140 that relates to more than one group. In general, once block 415 is complete, a set of CCPOs will have been computed, i.e., one CCPO will have been computed for each group specified as described above with respect to the block 410, whereupon each of the CCPOs may be stored, e.g., in a memory of the server 115, the data store 120, etc.

In general, the block 415, and hence the remainder of the process 400, should be performed only for groups having a sufficient amount of data. For example, where groups are defined according to traffic sources 105, a traffic source 105 should have provided a minimum threshold number of clicks since a last time the process 400 was executed. For example, in one implementation, the minimum threshold number of clicks is 50.

Next, in a block 420, an average CCPO for all groups is computed. A formula for the average CCPO where there are n groups is:

CCPO_{avg}=(CCPO₁+CCPO₂+ . . . +CCPOₙ)/n.

Next, in a block 425, bid modifiers for each group for a contract are determined using the CCPO for each group and the average CCPO. They formula for a contract-specific group-specific bid modifier may be:

GBMⱼ=CCPO_{avg}/CCPOⱼ,

where, assuming that there are n groups, and j is an index ranging from 1 to n, GBMⱼ is the contract-specific group-specific bid modifier for a group j, and CCPOⱼ is the CCPO for the group j.

In general, the foregoing formula reflects that GBM should be greater than 1 (or 100 percent), where a group's outcomes are good. That is, GBM should be higher when it is desirable to have higher bids in association with a group. Similarly, GBM should be less than 1 where outcomes associated with a group are poor, or at least relatively less good, than other groups. That is, if a CCPO value is less than 100 percent, then the group associated with that CCPO value is providing relatively good outcomes for a relatively low cost. Therefore, bid modifiers for that group should be enhanced to promote advertisements 125 associated with the group, e.g., to promote advertisements 125 being provided to a traffic source 105 included in the group. Conversely, high CCPO values mean that that an advertiser is paying relatively high fees to obtain relatively poor outcomes. In this instance, bid modifiers should be adjusted downward.

In one implementation, the contract-specific group-specific bid modifier GBM is subject to limitations. As mentioned above, it may be undesirable for modifiers to be subjected to adjustments over a certain threshold, because the fact of such adjustments may be unpredictable. Therefore, in this exemplary implementation, a ceiling and floor are applied to each contract-specific group-specific bid modifier GBMⱼ. Specifically in this exemplary implementation, a floor of 95 percent, and a ceiling of 105 percent are applied to the contract-specific group-specific bid modifier. Such floor or ceiling is applied for reasons discussed above, i.e., to prevent chaotic or unpredictable changes in volumes of traffic, etc. from adjusting amounts of bids related to a contract. The forgoing values for the floor and the ceiling have been empirically found to smooth bidding behavior and promote more even spending of a campaign budget. For example, the floor prevents bids from being so low that they will never succeed. The ceiling addresses anomalies such as holidays or other days when traffic volumes are low, and bids might otherwise be higher than warranted.

Further, in an exemplary implementation, any contract-specific group-specific bid modifier having a value between 97 percent and 103 percent (i.e., 0.97 and 1.03), is set to have a value of 1. The rationale behind this rule is to minimize unnecessary adjustments to bids, again to minimize unpredictable changes to behavior related to a campaign, such as traffic volumes, number of successful bids, etc.

Next, in a block 430, using the contract-specific group-specific bid modifiers determined as described above with respect to the block 425, and also the adjusted contract-specific bid modifiers described above with respect to the block 330 of the process 300, final contract-specific, group-specific bid modifiers 140 are determined. Such bid modifiers may be stored in data store 120, e.g., in contract data 130. An exemplary formula for determining a final bid modifier 140 is:

FBMⱼ=CSBM_{adj}*GBMⱼ.

Thus, for example, if CSBM_{adj} is 105 percent, and GBMⱼ is 85.375 percent, then the final bid modifier FBMⱼ 140 is 88.5 percent.

Further, the final bid modifier 140 FBMⱼ may be subjected to a ceiling or a floor, again to prevent unpredictable or extreme impacts on a campaign budget. For example, in one implementation, with respect to the final bid modifier 140, a ceiling is 125 percent (1.25) and a floor is 70 percent (0.7).

Note that, in the block 430, a plurality of adjusted contract-specific bid modifiers, each computed as described above with respect to the block 330, could be aggregated, e.g., averaged, to obtain a value used as described with respect to the adjusted contract-specific bid modifier used in the block 430. For example, the plurality of contract-specific bid modifiers could be for a set of related contracts, bid modifiers related to an advertiser, or bid modifiers aggregated in some other way.

Following the block 430, the process 400 ends.

The processes 300 and 400 are generally executed periodically for each contract in a set of contracts. For example, in one implementation, the processes 300 and 400 may be executed once or twice a week for each contract in a set of one or more contracts. If the processes 300 and 400 are executed too often, e.g., multiple times a day, then the data store 120 is unlikely to accumulate useful insufficient activity data 135 four further adjustments to final bid modifiers 140. On the other hand, if the processes 300 and 400 are not executed often enough, then final bid modifiers 140 may not reflect activity data 135 to an optimal or near-optimal degree.

FIG. 5 illustrates an exemplary process 500 for bidding to provide, and providing, digital advertisements.

The process 500 begins in a block 505, in which, for at least one contract, and generally for a set of contracts, the advertising server 115 applies the final bid modifier 140 to bid amounts associated with the contract for specified groups associated with the bid modifier 140. The advertising server 115 may then submit the bids to one or more traffic sources 105, e.g., according to an application program interface (API) of the traffic source 105, such as is known. Accordingly, the advertising server 115 may provide advertisements 125 to traffic sources 105 according to an advertiser's contract for a campaign based on bids modified by the modifier 140. As mentioned above, the processes 300 and 400 may be executed periodically, e.g., once or twice a week, whereupon the block 505 is executed as part of the process 500.

Next, in a block 510, the advertising server 115 receives traffic, i.e., a request for an advertisement 125, and provides the requested advertisement 125. Such request indicates that a bid has been successful. A traffic source 105 generally may provide a request for an advertisement 125 at any time. Thus, the blocks 510-520 may be executed, and generally are executed, with a much greater frequency than the block 505 described above.

Next, in a block 515, the advertising server 115 tracks any outcomes from providing the advertisement 125. For example, the advertisement 125 may include a link that is selected by a user, may lead a user to a webpage where other links are selected, a view coupon link associated with the advertisement 125 may be selected, etc.

Next, in a block 520, the advertising server 115 records the amount of the budget spent for a contract associated with the advertisement 125 provided as described above with respect to the block 510.

Following the block 520, the process 500 ends.

### CONCLUSION

Computing devices such as servers included in the portal 120, etc., may employ any of a number of computer operating systems, including, but by no means limited to, versions and/or varieties of the Microsoft Windows® operating system, the iOS by Apple Computer, Inc., Android by Google, Inc., the Unix operating system (e.g., the Solaris® operating system distributed by Sun Microsystems of Menlo Park, Calif.), the AIX UNIX operating system distributed by International Business Machines (IBM) of Armonk, N.Y., and the Linux operating system. Computing devices in general may include any one of a number of computing devices, including, without limitation, a computer workstation, a desktop, notebook, laptop, or handheld computer, or some other computing device.

Computing devices such as those discussed herein generally each include instructions executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases or data stores described herein, e.g., data store 145, etc., may include various kinds of mechanisms for storing, accessing, and retrieving various kinds of data, including a hierarchical database, a set of files in a file system, an application database in a proprietary format, a relational database management system (RDBMS), etc. Each such database or data store is generally included within a computing device employing a computer operating system such as one of those mentioned above, and are accessed via a network in any one or more of a variety of manners. A file system may be accessible from a computer operating system, and may include files stored in various formats. An RDBMS generally employs Structured Query Language (SQL) in addition to a language for creating, storing, editing, and executing stored procedures, such as the PL/SQL language mentioned above. Database 115 may be any of a variety of known RDBMS packages, including IBMS DB2, or the RDBMS provided by Oracle Corporation of Redwood Shores, Calif.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A method, comprising:
defining a plurality of outcomes resulting from display of a digital advertisement;
assigning a score to each of the outcomes;
tracking outcomes from the display of the digital advertisement, thereby generating a set of tracked outcomes;
aggregating the outcomes according to a group of attributes associated with the display of the digital advertisement; and
determining a group-specific bid modifier for the digital advertisement.

2. The method of claim 1, wherein the bid modifier is determined based at least in part on a cost of outcomes associated with the group and a bid modifier that is not group-specific.

3. The method of claim 1, wherein the outcomes include at least one of a user click on the advertisement, a link to view a coupon included in the advertisement, and a user visit to a site associated with the advertisement.

4. The method of claim 1, wherein the attributes include at least one of an identifier of a traffic source, geographic location, and a content category.

5. The method of claim 1, wherein the group-specific bid modifier is further specific to an advertising campaign.

6. The method of claim 1, wherein determining the bid modifier includes imposing a limit on the magnitude of the bid modifier if the bid modifier exceeds a specified threshold.

7. The method of claim 1, further comprising using the bid modifier to adjust a bid amount provided to a traffic source.

8. A computing device that includes a processor and a memory, the device configured to:
define a plurality of outcomes resulting from display of a digital advertisement;
assign a score to each of the outcomes;
track outcomes from the display of the digital advertisement, thereby generating a set of tracked outcomes;
aggregate the outcomes according to a group of attributes associated with the display of the digital advertisement; and
determine a group-specific bid modifier for the digital advertisement.

9. The device of claim 8, wherein the bid modifier is determined based at least in part on a cost of outcomes associated with the group and a bid modifier that is not group-specific.

10. The device of claim 8, wherein the outcomes include at least one of a user click on the advertisement, a link to view a coupon included in the advertisement, and a user visit to a site associated with the advertisement.

11. The device of claim 8, wherein the attributes include at least one of an identifier of a traffic source, geographic location, and a content category.

12. The device of claim 8, wherein the group-specific bid modifier is further specific to an advertising campaign.

13. The device of claim 8, wherein determining the bid modifier includes imposing a limit on the magnitude of the bid modifier if the bid modifier exceeds a specified threshold.

14. The device of claim 8, further configured to use the bid modifier to adjust a bid amount provided to a traffic source.

15. A non-transitory computer-readable medium tangibly embodying instructions executable by a computer processor, the instructions comprising instructions for:
defining a plurality of outcomes resulting from display of a digital advertisement;
assigning a score to each of the outcomes;
tracking outcomes from the display of the digital advertisement, thereby generating a set of tracked outcomes;
aggregating the outcomes according to a group of attributes associated with the display of the digital advertisement; and
determining a group-specific bid modifier for the digital advertisement.

16. The medium of claim 15, wherein the bid modifier is determined based at least in part on a cost of outcomes associated with the group and a bid modifier that is not group-specific.

17. The medium of claim 15, wherein the outcomes include at least one of a user click on the advertisement, a link to view a coupon included in the advertisement, and a user visit to a site associated with the advertisement.

18. The medium of claim 15, wherein the attributes include at least one of an identifier of a traffic source, geographic location, and a content category.

19. The medium of claim 15, wherein the group-specific bid modifier is further specific to an advertising campaign.

20. The medium of claim 15, wherein determining the bid modifier includes imposing a limit on the magnitude of the bid modifier if the bid modifier exceeds a specified threshold.

21. The medium of claim 15, the instructions further comprising instructions for using the bid modifier to adjust a bid amount provided to a traffic source.
